(19) United States
(12) Patent Application Publication
(10) Pub. No.: US 2015/0274533 A1
(43) Pub. Date: Oct. 1, 2015

(54) POLYCRYSTALLINE DIAMOND, MANUFACTURING METHOD THEREOF AND TOOL

(71) Applicant: SUMITOMO ELECTRIC INDUSTRIES, LTD., Osaka-shi, Osaka (JP)

(72) Inventors: Keiko Arimoto, Itami-shi (JP); Hitoshi Sumiya, Itami-shi (JP)

(21) Appl. No.: 14/436,040

(22) PCT Filed: Aug. 11, 2014
(86) PCT No.: PCT/JP2014/071174

§ 371 Date: Apr. 15, 2015

(30) Foreign Application Priority Data
Aug. 23, 2013 (JP) 2013-173495

(51) Int. Cl. C01B 31/06; B32B 9/00; B32B 18/00

(52) U.S. Cl. CPC C01B 31/06; B32B 18/00; B32B 9/007; C04B 2237/363

(57) ABSTRACT

Polycrystalline diamond having excellent resistance to crack propagation is provided. The polycrystalline diamond includes layered diamond and granular diamond. The layered diamond is formed by laminating plate-like diamond layers. When the polycrystalline diamond is observed in an arbitrary cross section, the layered diamond appearing at an observation visual field in the cross section occupies an area of more than or equal to 90% of the total area of the polycrystalline diamond in the observation visual field.

### TECHNICAL FIELD

The present invention relates to polycrystalline diamond, a manufacturing method thereof and a tool, and particularly relates to polycrystalline diamond having an orientation in a (111) plane, a manufacturing method thereof and a tool.

### BACKGROUND ART

Conventionally, diamond single crystals have mainly been used for tools, such as a wire drawing die and a nozzle, required to have wear resistance along a cylindrical side surface. However, since single crystalline diamond varies in amount of wear (uneven wear) depending on its crystal orientation, a deviation from its original shape increases with the lapse of service hour. For example, when single crystalline diamond is used for a tool, such as a die, a nozzle, or an orifice, if its hole originally has a circular shape, the hole shape may become a polygon, such as a hexagon, with the lapse of service hour.

Polycrystalline diamond produced with the use of a sintering aid is produced by, for example, sintering diamond powder as a raw material with a sintering aid under high pressure and high temperature conditions where diamond is thermodynamically stable (generally, at a pressure of approximately more than or equal to 5 GPa and less than or equal to 8 GPa and a temperature of approximately more than or equal to 1300° C. and less than or equal to 2200° C.). In this case, the sintering aid is contained in the resultant polycrystalline diamond. This sintering aid greatly affects the polycrystalline diamond in terms of mechanical properties, such as hardness and strength, as well as heat resistance.

In addition, polycrystalline diamond from which the sintering aid has been removed by acid treatment, and sintered diamond having excellent heat resistance in which heat-resistant silicon carbide (SiC) is used as a binder are also known, however, they are low in hardness and strength and insufficient in mechanical characteristics (hardness characteristics and wear resistance) as a tool material.

Naturally produced polycrystalline diamonds (carbonado, ballas and the like) are also known. Some of them are used for a drill bit, but are hardly used industrially because of their great fluctuations in material properties and small production.

In contrast, T. Irifune and H. Sumiya, “Nature of Polycrystalline Diamond Synthesized by Direct Conversion of Graphite Using Kawai-Type Multianvil Apparatus”, “New Diamond and Frontier Carbon Technology”, 14 (2004) pp. 313-327 (NPD 1) and Sumiya and Irifune, “Synthesis of High-Purity Nano-Polycrystalline Diamond and its Characterization”, SEI Technical Review, 165 (2004) pp. 68-74 (NPD 2) each disclose a method of obtaining a dense and high-purity polycrystalline diamond by direct conversion and sintering by indirect heating at an ultra-high pressure of more than or equal to 12 GPa and an ultra-high temperature of more than or equal to 2200° C. with the use of high-purity, highly-crystalline graphite used as a starting material. The polycrystalline diamond obtained by the method described in above-mentioned NPD 1 or 2 has very high hardness and excellent wear resistance.

### CITATION LIST

### Non Patent Document

NPD 1: T. Irifune and H. Sumiya, “Nature of Polycrystalline Diamond Synthesized by Direct Conversion of Graphite Using Kawai-Type Multianvil Apparatus”, “New Diamond and Frontier Carbon Technology”, 14 (2004) pp. 313-327
NPD 2: Sumiya and Irifune, “Synthesis of High-Purity Nano-Polycrystalline Diamond and its Characterization”, SEI Technical Review, 165 (2004) pp. 68-74

### SUMMARY OF INVENTION

### Technical Problem

However, the polycrystalline diamond synthesized by the above-described method is disadvantageous in that fractures and/or cracks are likely to occur.

The present invention was made to solve the above problem, and a main object of the present invention is to provide polycrystalline diamond having excellent resistance to crack propagation.

### Solution to Problem

Polycrystalline diamond of the present invention is polycrystalline diamond comprising layered diamond and granular diamond. The layered diamond is formed by laminating plate-like diamond layers. When the polycrystalline diamond is observed in an arbitrary cross section, the layered diamond appearing at an observation visual field in the cross section occupies an area of more than or equal to 90% of the total area of the polycrystalline diamond in the observation visual field.

### Advantageous Effects of Invention

According to the present invention, polycrystalline diamond having excellent resistance to crack propagation can be obtained.

### BRIEF DESCRIPTION OF DRAWINGS

FIG. 1 is a schematic view of a cutting tool according to a first embodiment

FIG. 2 is a flowchart showing a method for manufacturing polycrystalline diamond according to the first embodiment.

FIG. 3 is a schematic view of a wire drawing die according to the first embodiment.

FIG. 4 is a sectional view taken along the central axis of a through-hole of the wire drawing die shown in FIG. 3.

FIG. 5 is an X-ray diffraction spectrum of a carbon material of Example 1-2.

FIG. 6 is an X-ray diffraction spectrum of polycrystalline diamond of Example 1-2.

FIG. 7 is a cross-sectional schematic view of the structure of polycrystalline diamonds according to the first and second embodiments.

### DESCRIPTION OF EMBODIMENTS

Hereinafter, embodiments of the present invention will be described with reference to the drawings. It is noted that, in the drawings, the same or corresponding portions have the same reference characters allotted, and description thereof will not be repeated.

### Description of Embodiments of Claimed Invention

First, outlines of embodiments of the present invention will be listed.
(1) Polycrystalline diamond according to the present embodiment is polycrystalline diamond including layered diamond and granular diamond. The layered diamond is formed by laminating plate-like diamond layers. When the polycrystalline diamond is observed in an arbitrary cross section, the layered diamond appearing at an observation visual field in the cross section occupies an area of more than or equal to 90% of the total area of the polycrystalline diamond in the observation visual field.

As a result of repeated wholehearted studies for solving the above-described problem, the inventors of the present application have found out that polycrystalline diamond in which, when the polycrystalline diamond is observed in an arbitrary cross section, the layered diamond occupies more than or equal to 90% of the total area of the polycrystalline diamond in the observation visual field (the area occupied by the structure of the polycrystalline diamond in the observation visual field and including layered diamond and granular diamond), has high resistance to crack propagation. The reason why resistance to crack propagation is considered to be increased is because, even when a microcrack is produced in the polycrystalline diamond upon receipt of external force, the layered diamond having various orientations turns aside and relieves the crack in the longitudinal direction of the plate-like diamond (the change in the direction in which the crack extends results in prevention of growth of the crack).

(2) The polycrystalline diamond according to the present embodiment can have a surface in which a ratio I₍₂₂₀₎/I₍₁₁₁₎ of an X-ray diffraction intensity I₍₂₂₀₎ of a (220) plane of the diamond to an X-ray diffraction intensity I₍₁₁₁₎ of a (111) plane of the diamond is more than or equal to 0.35.

Since the polycrystalline diamond obtained by the method described in above NPD 1 or 2 exhibits isotropy, it is difficult for the (111) plane exhibiting particularly excellent hardness characteristics and wear resistance in the diamond to be utilized in the wear direction of a tool. As a result of repeated wholehearted studies for solving this problem, the inventors of the present application have found out that by directly converting a carbon material having a C-axis orientation and very high crystallinity at an ultra-high pressure and an ultra-high temperature, polycrystalline diamond having a surface where the orientation of the (111) plane of the diamond is extremely low is obtained. Specifically, it has been found out that, in the above-described polycrystalline diamond, the (ill) plane of the diamond in a surface parallel to the (002) plane of the carbon material has very low orientation.

The polycrystalline diamond according to the present embodiment is polycrystalline diamond composed of a single-phase diamond structure, and has a surface in which a ratio I₍₂₂₀₎/I₍₁₁₁₎ of an X-ray diffraction intensity I₍₂₂₀₎ of a (220) plane of the diamond to an X-ray diffraction intensity I₍₁₁₁₎ of a (111) plane of the diamond is more than or equal to 0.35. Here, the “single-phase diamond” indicates that neither a sintering aid or a binder is contained.

That is, the polycrystalline diamond according to the present embodiment has an exposed surface in which the (111) plane of single crystalline diamond has extremely low orientation as compared with conventional polycrystalline diamond. It is presumed that the polycrystalline diamond of the present invention accordingly includes a lame number of (111) planes of the diamond extending in a direction crossing (more preferably, perpendicular to) the exposed surface and oriented at random around an axis perpendicular to the exposed surface. The inventors of the present application have actually confirmed that the above-described polycrystalline diamond exhibits excellent wear resistance within the surface perpendicular to the exposed surface

(3) The polycrystalline diamond according to the present embodiment further includes a plurality of impurities other than the diamond, and each of the plurality of impurities can have a concentration of less than or equal to 0.01 mass %. Then, even if the ratio of the layered diamond is high to reduce the contact area of the grain boundary, impurities can be prevented from oozing to the grain boundary to be the starting point of stress concentration. As a result, stress can be prevented from concentrating on the contact interface, which can prevent fractures, cracks or the like from occurring.

(4) A tool according to the present embodiment includes the polycrystalline diamond described in any one of (1) to (3) above. The tool can thus have excellent resistance to crack propagation.

If the tool according to the present embodiment is provided with polycrystalline diamond including a surface in which the ratio I₍₂₂₀₎/I₍₁₁₁₎ of the X-ray diffraction intensity is more than or equal to 0.35, it is particularly suitable for tools, such as a die, a scribing wheel, a nozzle, and a wire guide, whose work surface with a work piece is curvilinear (including the case where the cross section has a circumferential or arcuate shape) and whose wear direction extends radially from the work surface. These tools can be tools having excellent wear resistance by arranging the surface perpendicular to the above-described exposed surface of the polycrystalline diamond according to the present embodiment as the work surface. Cutting tools whose work surface with a work piece is planar and whose wear direction extends perpendicularly to the work surface and wear resistant tools, such as a scriber dresser, can have excellent wear resistance by arranging the surface perpendicular to the above-described exposed surface as the work surface.

(5) A method for manufacturing polycrystalline diamond according to the present embodiment includes the steps of preparing a carbon material made of graphitic carbon having a degree of graphitization in X-ray diffractometry of more than or equal to 0.8, and directly converting the carbon material into diamond in a pressure and temperature range where diamond is thermodynamically stable.

Polycrystalline diamond having high resistance to crack propagation can thereby be obtained.

(6) in the method for manufacturing polycrystalline diamond according to the present embodiment, the step of preparing a carbon material includes the steps of preparing an oriented carbon material having an orientation along a C-axis, and subjecting the oriented carbon material to a heat treatment at more than or equal to 2000° C. to produce a carbon material in which a full width at half maximum of an X-ray diffraction peak of a (002) plane is more than or equal to 0 and less than or equal to 0.2°.

Polycrystalline diamond having excellent wear resistance can thereby be obtained.

(7) In the method for manufacturing polycrystalline diamond according to the present embodiment, preferably, the carbon material prepared in the step of preparing a carbon material contains a plurality of impurities other than carbon, and each of the plurality of impurities has a concentration of less than or equal to 0.01 mass %. Then, in the polycrystalline diamond obtained by this manufacturing method, impurity concentration can be made as very low as 0.01 mass %. As a result, even if the ratio of the layered diamond in the polycrystalline diamond is high and the contact area of the grain boundary decreases, impurities can be prevented from depositing at the grain boundary to be the starting point of stress concentration, which can prevent fractures, cracks or the like from occurring.

### Details of Embodiments of Claimed Invention

Hereinafter, embodiments of the present invention will be described with reference to the drawings.

### First Embodiment

Polycrystalline diamond according to the present first embodiment is a polycrystal of single-phase diamond. That is, the polycrystalline diamond substantially does not contain a binder, a sintering aid, a catalyst, or the like. At this time, the polycrystalline diamond has a mean particle diameter of approximately less than or equal to 100 urn. That is, the polycrystalline diamond according to the present embodiment has a crystalline structure in which crystal grains having a mean particle diameter of approximately less than or equal to 0.100 nm are directly bound firmly to each other and which is compact with very few voids.

Furthermore, the polycrystalline diamond according to the present embodiment has a surface in which a ratio I₍₂₂₀₎/I₍₁₁₁₎ of X-ray diffraction intensity I₍₂₂₀₎ of the (220) plane of the polycrystalline diamond to X-ray diffraction intensity I₍₁₁₁₎ of the (111) plane of the polycrystalline diamond is more than or equal to 0.35. The polycrystalline diamond produced by the conventional powder compression method has a surface in which the ratio I₍₂₂₀₎/I₍₁₁₁₎ of the above-described X-ray diffraction intensity is approximately more than or equal to 0.15 and less than or equal to 0.30. Therefore, the polycrystalline diamond of the present embodiment has an exposed surface in which the (111) plane of single crystalline diamond has extremely low orientation as compared with conventional polycrystalline diamond (hereinafter, also referred to as a (111) low oriented surface). In other words, the polycrystalline diamond according to the present embodiment includes a larger number of (111) planes of single crystalline diamond not appearing at the exposed surface than conventional polycrystalline diamond. Therefore, it is presumed that the polycrystalline diamond of the present embodiment includes a larger number of (111) planes of single crystalline diamond that extend in the direction crossing the exposed surface and that are oriented at random around an axis perpendicular to the exposed surface than conventional polycrystalline diamond. As a result, it is presumed that the polycrystalline diamond according to the present embodiment has excellent wear resistance in the surface perpendicular to the exposed surface ((111) low oriented surface).

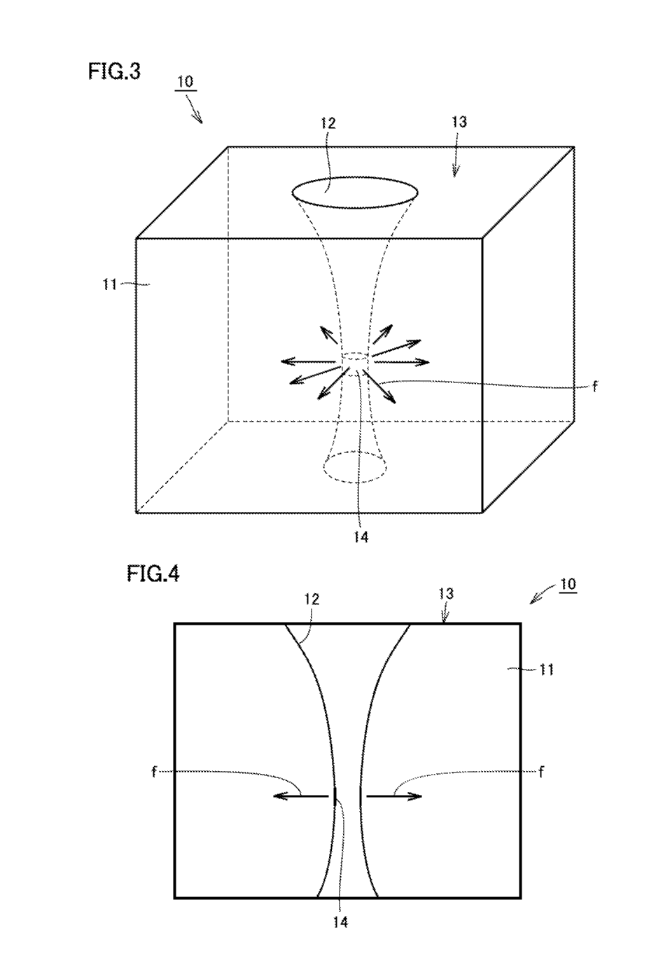

Actually, for the polycrystalline diamond made of single-phase diamond and having a mean particle diameter of less than or equal to 100 nm in the examples which will be described later, a die (see FIG. 3) in which an exposed surface ((111) low oriented surface) in which above-described X-ray diffraction intensity ratio I₍₂₂₀₎/I₍₁₁₁₎ is 0.4 to 2.4 is used as a drilled surface 13 has excellent wear resistance as compared with a die formed through use of conventional polycrystalline diamond. The wear direction of a die is a direction extending radially from a through-hole, and extends in a plane parallel to drilled surface 13. That is, since the above-described polycrystalline diamond has excellent wear resistance particularly in the case where the wear direction is in parallel to the exposed surface ((111) low oriented surface) it has been confirmed that excellent wear resistance is exhibited in the surface perpendicular to the exposed surface ((111) low oriented surface). In the polycrystalline diamond according to the present embodiment, however, it is considered that similar elects will be obtained also when the (111) low oriented surface in which above-described X-ray diffraction intensity I₍₂₂₀₎/I₍₁₁₁₎ is more than or equal to 0.35 is used as drilled surface 13 of the die.

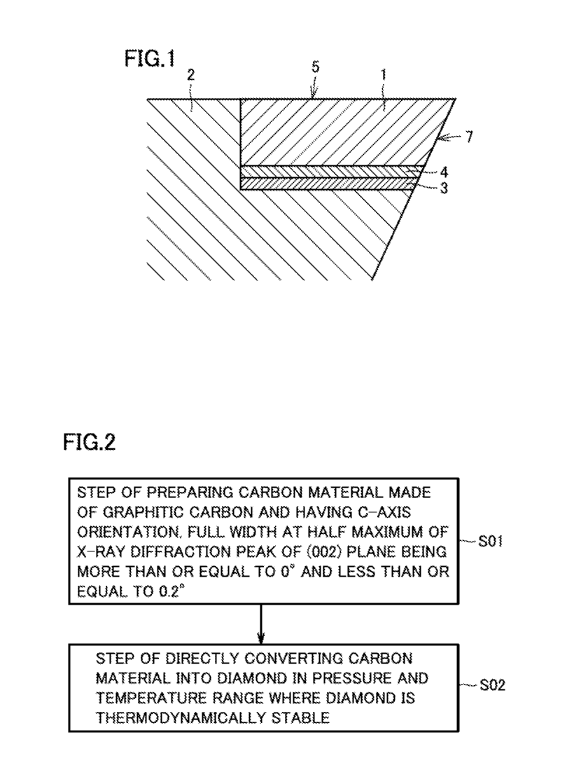

Next, referring to FIG. 1, the tool according to the present embodiment will be described. The tool according to the present embodiment is a cutting tool whose work surface with a work piece is planar and whose wear direction extends perpendicularly to the work surface. The above-described tool has the polycrystalline diamond according to the present embodiment such that the (111) low oriented surface is in parallel to the wear direction of the tool. For example, in a tool for an application in which particularly the amount of wear of a flank 7 is great, polycrystalline diamond 1 is fixed on a predetermined region of a base metal 2 with a brazing layer 3 and a metallization layer 4 interposed therebetween such that the (111) low oriented surface constitutes a cutting face 5. Then, it is presumed that, in the above-described polycrystalline diamond provided tier the tool, a surface presumed to have a larger number of (111) planes than in conventional polycrystalline diamond oriented at random can be provided to be perpendicular to the wear direction. As a result, it is considered that the cutting tool according to the present embodiment can have excellent wear resistance.

Next, referring to FIG. 2, the method for manufacturing polycrystalline diamond according to the present embodiment will be described. The method for manufacturing polycrystalline diamond according to the present embodiment includes a step (S01) of preparing a carbon material made of graphitic carbon and having a surface (hereinafter, also referred to as a (002) oriented surface) in which a ratio I₍₁₁₀₎/I₍₀₀₂₎ of an X-ray diffraction intensity I₍₁₁₀₎ of a (110) plane to an X-ray diffraction intensity I₍₀₀₂₎ of a (002) plane is less than or equal to 0.01, ill which the full width at half maximum of an X-ray diffraction peak of the (002) plane is more than or equal to 0° and less than or equal to 0.2°, and a step (S02) of directly converting the carbon material into diamond in a pressure and temperature range where diamond is thermodynamically stable.

First, in the step (S01), pyrolytic graphite (PG) is prepared. PG has a (002) oriented surface in which the ratio I₍₁₁₀₎/I₍₀₀₂₎ of X-ray diffraction intensity I₍₁₁₀₎ of the (110) plane to X-ray diffraction intensity I₍₀₀₂₎ of the (002) plane is less than or equal to 0.01 and further, the full width at half maximum of a (002) peak in X-ray diffraction is less than or equal to 0.2°. That is, PG prepared in this step (S01) has the (002) oriented surface, and has high crystallinity. In addition, the PG prepared in this step (S01) has a degree of graphitization of more than or equal to 0.8.

Next, in the step (S02), an ultra-high-pressure and high-temperature generator is used to convert the PG having high orientation and high crystallinity having been prepared in the previous step (S01), into polycrystalline diamond, and simultaneously sinter the PG. Sintering is carried out under the conditions of a pressure of more than or equal to 15 GPa and a temperature of more than or equal to 1500° C. Polycrystalline diamond having an exposed surface ((111) low oriented surface) in which the (111) plane of single crystalline diamond has extremely low orientation can thereby be obtained. The polycrystalline diamond is composed of a single-phase diamond structure substantially not containing a binder, a sintering aid, a catalyst, or the like.

It has been confirmed by the examples which will be described later that the polycrystalline diamond obtained in the step (S02) under the sintering conditions of a pressure of more than or equal to 15 GPa and less than or equal to 17 GPa and a temperature of more than or equal to 2000° C. and less than or equal to 2500° C. has an X-ray diffraction intensity ratio I₍₂₂₀₎/I₍₁₁₁₎ of more than or equal to 0.4 and includes the (111) low oriented surface. It has also been confirmed that the surface perpendicular to the (111) low oriented surface has excellent wear resistance. However, it is considered that polycrystalline diamond having similar characteristics can also be obtained under the conditions where single-phase diamond is thermodynamically stable, that is, under the sintering conditions of a pressure of approximately more than or equal to 15 GPa and a temperature of approximately more than or equal to 1500° C.

As described above, since the polycrystalline diamond according to the present embodiment includes the exposed surface (111) low oriented surface) in which the (111) plane of diamond has extremely low orientation, it is presumed to include a larger number of (111) planes in the direction crossing the exposed surface than conventional polycrystalline diamond. In contrast, since the polycrystalline diamond obtained by the method described in above-mentioned NPD 1 or 2 exhibits isotropy, it is difficult for the (111) plane exhibiting excellent hardness characteristics and wear resistance particularly in diamond to be utilized in the wear direction of the tool.

That is, it is presumed that the polycrystalline diamond according to the present embodiment has the (111) plane appearing at the surface perpendicular to the exposed surface with a probability higher than in conventional polycrystalline diamond. Therefore, the polycrystalline diamond according to the present embodiment is considered to have excellent mechanical properties in the surface perpendicular to the exposed surface. Since the tool according to the present embodiment is provided such that the above-described exposed surface of the polycrystalline diamond of the present embodiment is in parallel to the wear direction of the tool, it is presumed that the (111) plane appears at the work surface with a work piece with a higher probability. Therefore, the tool according to the present embodiment is considered to have excellent wear resistance. In addition, according to the method for manufacturing polycrystalline diamond according to the present embodiment, a pyrolytic graphite exhibiting high orientation in the (002) plane (C-axis orientation) and high crystallinity is adopted as a carbon material. This is converted into polycrystalline diamond under the conditions where single-phase diamond is thermodynamically stable, and simultaneously this is sintered. The polycrystalline diamond according to the present embodiment can thereby be obtained.

Here, characteristic structures of the first embodiment of the present invention will be listed although some of them overlap with those in the embodiment described above.

Polycrystalline diamond 1 according to the embodiment of the present invention is polycrystalline diamond 1 composed of a single-phase diamond structure, and has a surface ((111) low oriented surface) in which the ratio I₍₂₂₀₎/I₍₁₁₁₎ of the X-ray diffraction intensity I₍₂₂₀₎ of the (220) plane of polycrystalline diamond 1 to the X-ray diffraction intensity I₍₁₁₁₎ of the (111) plane of polycrystalline diamond 1 is more than or equal to 0.35.

Polycrystalline diamond 1 according to the embodiment of the present invention is thus presumed to have a large number of (111) planes present in the direction crossing the (111) low oriented surface. Actually, it could have been confirmed, based on the example which will be described later, that polycrystalline diamond 1 according to the embodiment of the present invention can exhibit excellent wear resistance in the direction perpendicular to the (111) low oriented surface.

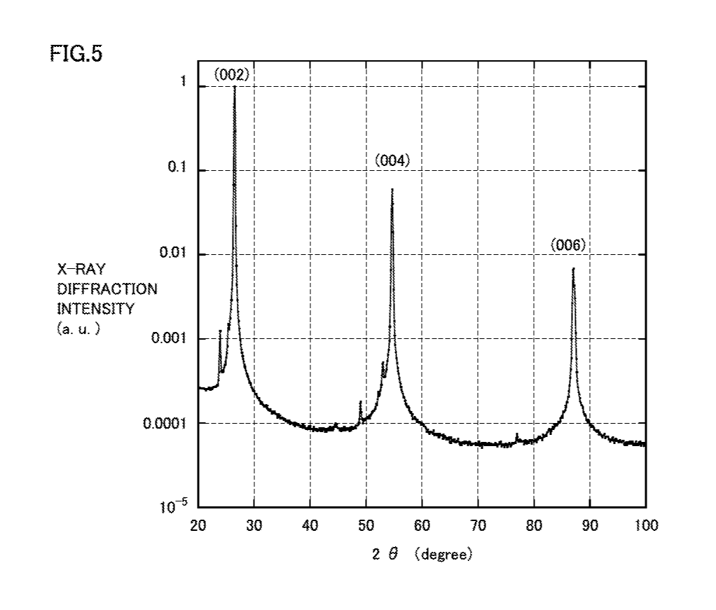

Polycrystalline diamond 1 described above can be used for a tool. The tool according to the embodiment of the present invention is a tool whose work surface with a work piece is circumferential (including the case of arcuate) and whose wear direction extends radially from the work surface (see FIGS. 3 and 4), or a tool whose work surface with a work piece is planar and whose wear direction extends perpendicularly to the work surface (see FIG. 1). The above-described tool includes polycrystalline diamond 1 according to the embodiment of the present invention such that the (111) low oriented surface thereof extends in parallel to the wear direction of the tool. Examples of the tool whose work surface with a work piece is planar and whose wear direction extends perpendicularly to the work surface include cutting tools and wear resistant tools, such as a scriber dresser. Examples of the tool whose work surface with a work piece is circumferential (including the case of arcuate) and whose wear direction extends radially from the work surface include tools, such as a wire drawing die, a scribing wheel, a nozzle, and a wire guide. Then, it is presumed that in polycrystalline diamond 1 described above provided for the tool, a surface presumed to have a larger number of (111) planes present than in conventional polycrystalline diamond oriented at random can be provided so as to be perpendicular to the wear direction. Therefore, it is considered that the wear resistance of the tool can thereby be improved.

Referring to in FIG. 1, in the cutting tool according to the embodiment of the present invention, the (111) low oriented surface in the polycrystalline diamond of the present embodiment is disposed at cutting face 5. Specifically, polycrystalline diamond 1 is fixed on a predetermined region of base metal 2 with brazing layer 3 and metallization layer 4 interposed therebetween such that the (111) low oriented surface constitutes cutting face 5. Accordingly, a tool having excellent wear resistance particularly for an application in which the amount of wear of flank 7 is great can provided.

The (111) low oriented surface in polycrystalline diamond 1 of the present embodiment may also be arranged at flank 7 of the cutting tool. In this case, a tool having excellent wear resistance and long life particularly for an application in which the amount of wear of cutting face 5 is great can be provided.

Referring to FIGS. 3 and 4, in a wire drawing die 10 according to the embodiment of the present invention, the (111) low oriented surface in polycrystalline diamond 11 of the present embodiment is arranged at drilled surface 13. Then, the surface in which the (111) planes of single crystalline diamond are oriented at a higher ratio in polycrystalline diamond 11 of the present embodiment can be arranged so as to be perpendicular to wear directions f of wire drawing die 10 (the directions extending radially from a through-hole 12). As a result, wire drawing die 10 can be improved in wear resistance and service life.

It is noted that, in polycrystalline diamonds 1 and 11 according to the embodiment of the present invention, it is considered that the (111) planes of the diamond are oriented at random around the axis perpendicular to the (111) low oriented surface. That is, when through-hole 12 is provided in the direction perpendicular to the (111) low oriented surface of polycrystalline diamonds 1 and 11 according to the embodiment of the present invention to obtain wire drawing die 10, it is considered that the (111) planes appear at the peripheral surface of through-hole 12 with a high probability, without concentrating on a specific orientation. Accordingly, in a work surface 14 with a work piece in through-hole 12, wear can be prevented from progressing anisotropically and the shape of work surface 14 can be maintained. Therefore, wire drawing die 10 according to the embodiment of the present invention can be improved in wear resistance of work surface 14, and deformation of work surface 14 with the lapse of service hour can be reduced, which can extend the service life. Actually, based on the examples which will be described later, wire drawing die 10 according to the embodiment of the present invention had excellent wear resistance as compared with a wire drawing die provided with isotropic polycrystalline diamond and a wire drawing die provided with polycrystalline diamond having a surface where the (111) plane has high orientation.

The method for manufacturing polycrystalline diamond according to the embodiment of the present invention includes a step (S01) of preparing a carbon material made of graphitic carbon and having an orientation along the C-axis, the full width at half maximum of the X-ray diffraction peak of the (002) plane being more than or equal to 0° and less than or equal to 0.2°, and a step (S02) of directly converting the carbon material into diamond in a pressure and temperature range where diamond is thermodynamically stable.

As a result of studies, the inventors of the present application have confirmed that polycrystalline diamonds 1 and 11 obtained by directly converting the carbon material having a C-axis orientation have an orientation. This is considered as a consequence of occurrence of diffusionless phase transition (martensitic transformation). Furthermore, the inventors of the present application have confirmed that the orientation of polycrystalline diamonds 1 and 11 obtained by direct conversion changes depending on the degree of crystallization of the above-described carbon material.

It has been confirmed that when the degree of crystallization of the carbon material having a C-axis orientation is relatively low, specifically, when the full width at half maximum of the X-ray diffraction peak of the (002) plane is more than or equal to 0.2°, the (111) plane of the diamond of the carbon material in polycrystalline diamonds 1 and 11 obtained by directly converting the carbon material under the above-described conditions is oriented in the [002] direction. In other words, the (002) oriented surface in the carbon material was transformed into the (111) oriented surface in polycrystalline diamonds 1 and 11 through diffusionless phase transition (martensitic transformation).

On the other hand, it has been confirmed that when the degree of crystallization of the carbon material having a C-axis orientation is relatively high, specifically, when the full width at half maximum of the X-ray diffraction peak of the (002) plane is more than or equal to 0° and less than or equal to 0.2°, the orientation of the (111) plane of the diamond in the [002] direction of the carbon material is extremely low in polycrystalline diamonds 1 and 11 obtained by directly converting the carbon material under the above-described conditions. In other words, the (002) oriented surface in the carbon material was transformed into the (111) low oriented surface in polycrystalline diamonds 1 and 11 through diffusionless phase transition (martensitic transformation). Regarding this, the inventors of the present application consider that the mechanism of diffusionless phase transition (martensitic transformation) changes depending, on the difference in the degree of crystallization between carbon materials to change the orientation of the (111) plane of the diamond in polycrystalline diamonds 1 and 11.

At this time, it is presumed that in polycrystalline diamonds 1 and 11 obtained by the above-described method for manufacturing polycrystalline diamond, the (111) plane of the diamond is not oriented at random as in conventional polycrystalline diamond formed by progress of diffusion phase transition in the direct conversion method, but many (111) planes of the diamond are included in the direction crossing the (11) low oriented surface of the polycrystalline diamond, it is also considered that some of many (111) planes included in the direction crossing the (111) low oriented surface is oriented in the direction perpendicular to the (111) low oriented surface. At this time, if a larger number of (111) planes of the diamond is oriented in the direction perpendicular to the (111) low oriented surface in the polycrystalline diamond, a larger number of (111) planes can be arranged perpendicularly to the wear direction by forming the tool with the (111) low oriented surface of the polycrystalline diamond arranged to be in parallel to the wear direction. In this case, the tool can more effectively make use of excellent hardness characteristics and wear resistance of the (111) plane of diamond.

Actually, it could have been confirmed that polycrystalline diamonds 1 and 11 obtained by the method for manufacturing polycrystalline diamond according to the embodiment of the present invention exhibit excellent wear resistance in the surface perpendicular its exposed surface (111) low oriented surface) (see the examples). It is therefore considered that polycrystalline diamonds 1 and 11 according to the embodiment of the present invention have a larger number of (111) planes of the diamond oriented in the direction perpendicular to the (111) low oriented surface. According to the above-described method for manufacturing polycrystalline diamond, polycrystalline diamonds 1 and 11 according to the embodiment of the present invention can be obtained.

The method for manufacturing polycrystalline diamond according to the embodiment of the present invention includes the steps of preparing a carbon material made of graphitic carbon and having an orientation along the C-axis, the full width at half maximum of the X-ray detraction peak of the (002) plane being more than or equal to 0° and less than or equal to 0.2°, and a step of sintering the carbon material under the conditions of a pressure of more than or equal to 15 GPa and less than or equal to 30 GPa and a temperature of more than or equal to 1500° C. and less than or equal to 3000° C. for direct conversion into diamond.

Even when setting the pressure and temperature conditions in the step of direct conversion into diamond as described above, the polycrystalline diamond according to the embodiment of the present invention can be obtained.

In the above-described method for manufacturing polycrystalline diamond, the carbon material may be graphite produced by a thermal decomposition method. In this case, by appropriately selecting conditions of the flow rate of a source gas for thermal decomposition, the temperature at the time of thermal decomposition and evaporation or the like, or conditions of the annealing temperature after vacuum evaporation or the like, pyrolysis graphite having an orientation along the C-axis, the full width at half maximum of the X-ray diffraction peak of the (002) plane being more than or equal to 0° and less than or equal to 0.2° can be produced. Then, the polycrystalline diamond of the present invention can also be manufactured.

In the above-described method for manufacturing polycrystalline diamond, the carbon material may be graphite obtained by subjecting a sheet-like organic substance to a high-temperature treatment. In this case, by appropriately selecting the temperature conditions for the high-temperature treatment, high-orientation graphite having an orientation along the C-axis, the full width at half maximum of the X-ray diffraction peak of the (002) plane being more than or equal to 0° and less than or equal to 0.2°, can be produced. Then, the polycrystalline diamond according to the embodiment of the present invention can also be manufactured.

In the above-described method for manufacturing polycrystalline diamond, the carbon material may be a compact obtained by orienting and compressing graphite powder. In this case, by appropriately selecting the pressure and temperature conditions at the time of compression, pyrolytic graphite having an orientation along the C-axis, the full width at half maximum of the X-ray diffraction peak of the (002) plane being more than or equal to 0° and less than or equal to 0.2°, can be produced. Then, the polycrystalline diamond according to the embodiment of the present invention can also be manufactured.

In the above-described method for manufacturing polycrystalline diamond, the carbon material is not limited to those described above. Any carbon material can be adopted as long as it has a C-axis orientation and a full width at half maximum of the X-ray diffraction peak of the (902) plane of less than or equal to 0.2°. Then, the polycrystalline diamond according to the embodiment of the present invention can also be manufactured.

Based on the examples which will be described later, first in the step (S01), a sheet-like organic substance was subjected to a high-temperature vacuum heat treatment as the high-temperature treatment to produce graphite exhibiting high orientation in the (002) plane (C-axis orientation). Next, in the step (S02), this graphite was sintered under the conditions of a pressure of more than or equal to 15 GPa and less than or equal to 17 GPa and a temperature of more than or equal to 2000° C. and less than or equal to 2500° C. it has been confirmed that polycrystalline diamond thus obtained has an exposed surface ((111) low oriented surface) in which the orientation of the (111) plane of single crystalline diamond is extremely low. In addition, it has also been confirmed that the polycrystalline diamond obtained by uniaxially compressing, in the step (S01), graphite powder while being oriented along the C axis, and subjecting it to a high-temperature treatment to produce graphite exhibiting high orientation in the (002) plane (C-axis orientation) and, in the step (S02), sintering this under the conditions of a pressure of more than or equal to 15 GPa and less than or equal to 17 GPa and a temperature of more than or equal to 2000° C. and less than or equal to 2500° C. has an exposed surface ((111) low oriented surface) which the orientation of the (111) plane of single crystalline diamond is extremely low.

### Second Embodiment

Next, polycrystalline diamond according to a second embodiment of the present invention and a manufacturing method thereof will be described.

The polycrystalline diamond according to the present second embodiment has granular diamond and layered diamond in which plate-like diamond layers are laminated.

The granular diamond refers to diamond whose length in the longitudinal direction (length of a long side) is less than 3 times the length in the short direction (length of a short side). It is noted that the short side refers to the maximum value of a length in a direction almost perpendicular to the long side.

The plate-like diamond is shaped such that the length in the longitudinal direction (length of the long side) is more than or equal to 3 times the length in the short direction (length of the short side) and such that the thickness is smaller than the lengths of the long side and the short side.

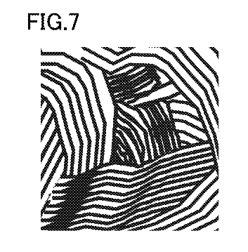

The layered diamond in which the plate-like diamond layers are laminated exists in a complicated structure with their orientations changed little by little relative to one another, as shown in FIG. 7. FIG. 7 is a cross-sectional schematic view when the polycrystalline diamond according to the second embodiment is observed in an arbitrary cross section. It is noted that although the granular diamond is not illustrated in FIG. 7, diamond particulates exist in the layered diamond in a distributed manner in the polycrystalline diamond according to the second embodiment. When the polycrystalline diamond according to the present embodiment is observed in au arbitrary cross section, the area of the layered diamond appearing at the observation visual field in the cross section occupies more than or equal to 90% of the total area of the polycrystalline diamond in the observation visual field. Here, cross-section observation of the polycrystalline diamond is accomplished by performing mirror polishing on an arbitrary cross section of the polycrystalline diamond, for example, and then observing the cross section (mirror surface) with a scanning electron microscope (SEM). The observation visual field in the cross-section observation of the polycrystalline diamond may have any size as long as the structure of the polycrystalline diamond can be observed, and, for example, the length of one side may be longer than the length of the layered diamond in the longitudinal direction. For example, the observation visual field may be 50 μm square.

The structure of each of the granular diamond and the plate-like diamond may be either cubic diamond or hexagonal diamond as long as it has a diamond structure. In addition, the polycrystalline diamond in which the present embodiment is involved is a polycrystal substantially made of diamond not containing a sintering aid or a catalyst except impurities. The polycrystalline diamond according to the present embodiment has an impurity concentration of less than or equal to 0.01 mass %.

Next, the method for manufacturing polycrystalline diamond according to the second embodiment will be described. The method for manufacturing polycrystalline diamond according to the second embodiment includes a step (S10) of preparing a carbon material made of graphitic carbon having a degree of graphitization in X-ray diffractometry of more than or equal to 0.8, and a step (S20) of directly converting the carbon material into diamond while applying moderate shearing stress to the carbon material in a pressure and temperature range where diamond is thermodynamically stable.

First, the carbon material made of graphitic carbon is prepared as a starting material (step (S10)). The graphitic carbon is a non-diamond carbon material isotropically oriented having a degree of graphitization in X-ray diffractometry (hereinafter, a degree of graphitization) of more than or equal to 0.8. In order to obtain graphitic carbon with high crystallinity having a degree of graphitization of more than or equal to 0.8, it is preferable to remove amorphous graphite as much as possible. Even in some graphitic carbon materials having a degree of graphitization of less than 0.8, the degree of graphitization can be increased to more than or equal to 0.8 also by annealing in methane gas at more than or equal to 2500° C. in this manner, the carbon material made of graphitic carbon having a degree of graphitization of more than or equal to 0.8 may be prepared.

Here, a degree of graphitization P of graphitic carbon in a non-diamond carbon material is obtained as follows. First, X-ray diffraction of the non-diamond carbon material is conducted to measure an interplanar spacing d₀₀₂ of the (002) plane of the graphite in the non-diamond carbon material. Next, a ratio p of a turbostratic structure portion of the non-diamond carbon material is calculated from interplanar spacing d₀₀₂ as measured, based on Equation (1) below. Degree of graphitization P is calculated from ratio p of the turbostratic structure portion thus obtained, based on Equation (2) below.

d₀₀₂=3.440−0.086×(1−p²) [Equation 1]

P=1−p [Equation 2]

In addition, the carbon material prepared in the step (S10) in the present embodiment has a very small amount of impurities. In the present specification, the “impurities” refer to elements other than carbon. Specifically, the concentration of each of impurities, such as nitrogen, hydrogen, oxygen, boron, silicon, and transition metal, is less than or equal to 0.01 mass %. That is, the impurity concentration in graphite is approximately less than or equal to the detection limit in SIMS (Secondary Ion Mass Spectrometry) analysis. For transition metal, the impurity concentration in graphite is approximately less than or equal to the detection limit in ICP (Inducticely Coupled Plasma) analysis or SIMS.

Next, the above-described carbon material is directly converted into diamond in a pressure and temperature range where diamond is thermodynamically stable (step (S20)). Specifically, the carbon material prepared in the previous step (S10) is placed under the pressure and temperature conditions where diamond is thermodynamically stable while applying moderate shearing stress, without adding either a sintering aid or a binder, thereby directly converting the carbon material into diamond and sintering the carbon material.

The pressure and temperature conditions where diamond is thermodynamically stable refer to such pressure and temperature conditions that a diamond phase is a thermodynamically stable phase in a carbon-based material. Such conditions that sintering can be carried out without adding either a sintering aid or a binder specifically refer to such conditions that the pressure is more than or equal to 13 GPa and the temperature is more than or equal to 1500° C., and preferably the pressure is more than or equal to 15 GPa and the temperature is more than or equal to 1500° C. and less than or equal to 2400° C.

Here, the sintering aid refers to a catalyst promoting sintering of a material serving as a source material, and an iron-group element metal such as Co (cobalt), Ni (nickel) and Fe (iron), carbonate such as CaCO₃ (calcium carbonate), and the like are exemplified. The binder refers to a material for binding materials serving as source materials, and ceramics such as SiC (silicon carbide) is exemplified.

In the step (S20), by placing the above-described carbon material under the pressure and temperature conditions where diamond is thermodynamically stable to be directly converted into diamond, the polycrystalline diamond according to the second embodiment can be obtained. It is noted that the high-pressure high-temperature generator used in this step (S20) is not particularly restricted as long as it is an apparatus capable of attaining pressure and temperature conditions where a diamond phase is a thermodynamically stable phase.

The polycrystalline diamond according to the second embodiment is suitably available for cutting tools wear resistant tools, grinding tools, and the like required to have toughness. More specifically, the polycrystalline diamond is suitably available for the material of precision tools, such as a cutting byte, a die, and a micro tool.

Next, operational effects of the polycrystalline diamond according to the second embodiment and the manufacturing method thereof will be described.

In the polycrystalline diamond according to the second embodiment, when the polycrystalline diamond is observed in an arbitrary cross section, the layered diamond occupies the major part of the total area of the polycrystalline diamond (more than or equal to 90% by area ratio) in the observation visual field in the cross section. That is, since the layered diamond has a high existence ratio in the structure of the polycrystalline diamond according to the second embodiment, when a microcrack is produced by external force, the layered diamond having various orientations can turn aside the crack in the longitudinal direction of the plate and relieve it.

Furthermore, since the polycrystalline diamond according to the second embodiment contains an extremely small amount of impurities of less than or equal to 0.01 mass %, the ratio occupied by the layered diamond is high, and even when the contact area of the grain boundary decreases, impurities can be prevented from depositing at the contact interface to cause stress concentration.

That is, the ratio occupied by the layered diamond in the structure of the polycrystalline diamond according to the second embodiment is higher than in the conventional polycrystalline diamond made of plate-like diamond and spherical diamond. Therefore, the polycrystalline diamond according to the second embodiment has higher resistance to crack propagation. Moreover, since the polycrystalline diamond according to the second embodiment has a low impurity concentration, fractures, cracks or the like can be effectively prevented from occurring although many layered diamond layers are provided.

It is noted that the polycrystalline diamond according to the first embodiment described above has a structure and operational effects similar to those of the polycrystalline diamond according to the second embodiment. That is, the polycrystalline diamond according to the first embodiment is polycrystalline diamond including layered diamond and granular diamond, and the layered diamond is formed by laminating plate-like diamond layers. Furthermore, when the polycrystalline diamond according to the first embodiment is observed in an arbitrary cross section, the area of the layered diamond appearing at the observation visual field in the cross section occupies more than or equal to 90% of the total area of the polycrystalline diamond in the observation visual field. In addition, in the method for manufacturing polycrystalline diamond according to the second embodiment, by using a starting material including the (002) oriented surface having a degree of graphitization of more than or equal to 0.8 and the ratio I₍₁₁₀₎/I₍₀₀₂₎ of X-ray diffraction intensity I₍₁₁₀₎ of the (110) plane to X-ray diffraction intensity I₍₀₀₂₎ of the (002) plane is less than or equal to 0.01, the Phil width at half maximum of a (002) peak in X-ray diffraction being less than or equal to 0.2°, the polycrystalline diamond according to the first embodiment can be obtained. Therefore, the polycrystalline diamond according to the first embodiment can have high resistance to crack propagation, and can prevent fractures, cracks or the like from occurring. By further including the structure described in the first embodiment, the polycrystalline diamond according to the first embodiment has high resistance to crack propagation, can prevent fractures, cracks or the like from occurring, and has excellent wear resistance.

### Example 1

Next, Example 1 of the embodiment will be described with reference to the drawings.

Polycrystalline diamonds according to Examples 1-1 and 1-2 were produced by the following method. First, as a carbon material, pyrolytic graphite having a C-axis orientation and a high degree of crystallization was prepared. Shown in FIG. 5 is an X-ray diffraction spectrum obtained when X-ray diffraction measurement was conducted with an arbitrary surface of pyrolytic graphite used as a measuring surface. The horizontal axis of FIG. 5 indicates a diffraction angle 2θ (unit: deg), and the vertical axis indicates the X-ray diffraction intensity in an arbitrary unit obtained by normalization by the peak intensity of the (002) plane. In the X-ray diffraction spectrum shown in FIG. 5, the X-ray diffraction peak of the (110) plane was not identified. That is, the pyrolytic graphite had a surface in which the ratio I₍₁₁₀₎/I₍₀₀₂₎ of X-ray diffraction intensity I₍₁₁₀₎ of the (110) plane to X-ray diffraction intensity I₍₀₀₂₎ of the (002) plane was 0. The full width at half maximum of the X-ray diffraction peak of the (002) plane of the pyrolytic graphite was 0.15. This pyrolytic graphite was held for 20 minutes under the conditions of a pressure of 15 GPa to 17 GPa and a temperature of approximately 2000° C. to 2500° C. using a ultra-high-pressure and high-temperature generator to be directly converted into diamond.

Furthermore, polycrystalline diamonds according to Examples 1 to 3 were produced by the following method. First, as a carbon material, a sheet-like organic substance was subjected to a high-temperature vacuum heat treatment to prepare highly-oriented graphite having a C-axis orientation and a high degree of crystallization. This highly-oriented graphite had a surface in which the above-described ratio I₍₁₁₀₎/I₍₀₀₂₎ of X-ray diffraction intensity was 0 The full width at half maximum of the X-ray diffraction peak of the (002) plane of this highly-oriented graphite was 0.14°. This highly-oriented graphite was held for 20 minutes under the conditions of a pressure of more than or equal to 15 GPa and less than or equal to 30 GPa and a temperature of approximately more than or equal to 1500° C. and less than or equal to 3000° C. using a ultra-high-pressure and high-temperature generator to be directly converted into diamond.

Furthermore, polycrystalline diamonds according to Examples 1 to 4 were produced by the following method. First, as a carbon material, a compact having a C-axis orientation and a high degree of crystallization was prepared, which was produced by uniaxially compressing graphite powder while being oriented along the C axis and subjecting it to a high-temperature vacuum treatment. The compact had a surface in which the above-described ratio I₍₁₁₀₎/I₍₀₀₂₎ of the X-ray diffraction intensity was 0.002. The full width at half maximum of the X-ray diffraction peak of the (002) plane of the compact was 0.17°. This compact was held for 20 minutes under the conditions of a pressure of 15 GPa to 17 GPa and a temperature of approximately 2000° C. to 2500° C. using a ultra-high-pressure and high-temperature generator while applying moderate shearing stress to be directly converted into diamond.

Polycrystalline diamonds of Comparative Examples 1-1 and 1-2 were produced by the following method. First, as a carbon material, a compact was prepared, which was produced by compressing graphite powder and subjecting it to a high-temperature treatment. The compact had a surface in which the above-described ratio I₍₁₁₀₎/I₍₀₀₂₎ of the X-ray diffraction intensity was 0.091. The full width at half maximum of the X-ray diffraction peak of the (002) plane of the compact was 0.40°. This compact was held for 20 minutes under the conditions of a pressure of 15 GPa to 17 GPa and a temperature of approximately 2000° C. to 2500° C. using a ultra-high-pressure and high-temperature generator to be directly converted into diamond.

The polycrystalline diamonds of Comparative Examples 1-3 and 1-4 were produced by the following method. First, as a carbon material, pyrolytic graphite having a C-axis orientation and a low degree of crystallization was prepared. This pyrolytic graphite had a surface in which the above-described ratio I₍₁₁₀₎/I₍₀₀₂₎ of the X-ray diffraction intensity was 0. The hill width at half maximum of the X-ray diffraction peak of the (002) plane of this pyrolytic graphite was 0.81°. This pyrolytic graphite was held for 20 minutes under the conditions of a pressure of 15 GPa to 17 GPa and a temperature of approximately 2000° C. to 2500° C. using a ultra-high-pressure and high-temperature generator to be directly converted into diamond.

It is noted that an X-ray diffractometer (X'Pert) provided by Koninklijke Philips N.V. was used for the X-ray diffraction conducted for investigating the orientation and the degree of crystallization of the above-described starting materials.

The orientation was evaluated with the above-described X-ray diffractometer. Specifically, the ratio I₍₁₁₀₎/I₍₀₀₂₎ of X-ray diffraction intensity I₍₁₁₀₎ of the (110) plane to X-ray diffraction intensity I₍₀₀₂₎ of the (002) plane of the carbon material obtained by X-ray diffractometry was calculated and evaluated.

The degree of crystallization was evaluated by the full width at half maximum of the X-ray diffraction peak of the (002) plane in the X-ray diffraction spectrum of the carbon material obtained with the above-described X-ray diffractometer.

The orientation of the polycrystalline diamond of each of Examples 1-1 to 1-4 and Comparative Examples 1-1 to 0.1-4 obtained as described above was measured by the following technique.

The orientation was evaluated with the above-described X-ray diffractometer. Specifically, in each polycrystalline diamond, the X-ray diffraction spectrum was previously acquired for an exposed surface corresponding to an evaluated surface in the X-ray diffraction in the carbon material. In this X-ray diffraction spectrum, the ratio I₍₂₂₀₎/I₍₁₁₁₎ of X-ray diffraction intensity I₍₂₂₀₎ of the (220) plane to X-ray diffraction intensity I₍₁₁₁₎ of the (111) plane was calculated and evaluated.

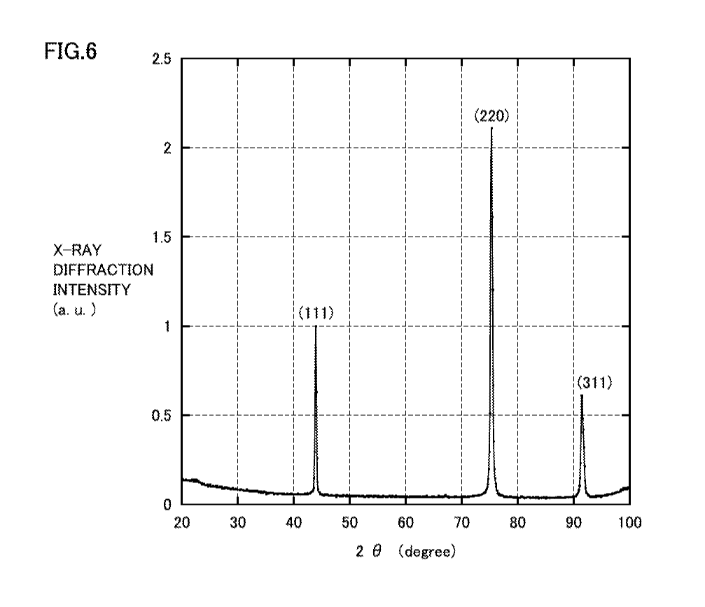

The results of the ratio I₍₂₂₀₎/I₍₁₁₁₎ of the above-described X-ray diffraction intensity and wear resistance of the polycrystalline diamond of each of Examples 1-1 to 1-4 and Comparative Examples 1-1 and 1-4 are shown in Table 1. The X-ray diffraction spectrum of the polycrystalline diamond of Example 2 is shown in FIG. 6. The horizontal axis of FIG. 6 indicates diffraction angle 2θ (unit: deg), and the vertical axis indicates the X-ray diffraction intensity in an arbitrary unit obtained by normalization by the peak intensity of the (002) plane.

TABLE 1

| | Carbon Material | | | Polycrystalline Diamond | |
|---|---|---|---|---|---|
| | | | Full width at half | Ratio of X-ray | |
| | | Ratio of X-ray | maximum ° of X-ray | diffraction | |
| | | diffraction intensity | diffraction peak of | intensity | Amount of |
| | Material | I(110)/I(002) | (002) plane | I(220)/I(111) | wear |
| Example 1-1 | pyrolytic graphite | 0 | 0.15 | 0.5 | 0.7 |
| Example 1-2 | pyrolytic graphite | 0 | 0.15 | 2.3 | 0.5 |
| Example 1-3 | organic-substance | 0 | 0.14 | 0.7 | 0.8 |
| | heat-treated | | | | |
| | graphite | | | | |
| Example 1-4 | graphite powder | 0.002 | 0.17 | 0.4 | 0.9 |
| | oriented compact | | | | |
| Comparative | powder | 0.091 | 0.40 | 0.18 | 1.0 |
| Example 1-1 | compressed | | | | |
| | graphite | | | | |
| Comparative | powder | 0.091 | 0.40 | 0.23 | 1.1 |
| Example 1-2 | compressed | | | | |
| | graphite | | | | |
| Comparative | pyrolytic graphite | 0 | 0.81 | 0.13 | 1.2 |
| Example 1-3 | | | | | |
| Comparative | pyrolytic graphite | 0 | 0.81 | 0.04 | 2.0 |
| Example 1-4 | | | | | |

As shown in Table 1, the ratio I₍₂₂₀₎/I₍₁₁₁₎ of the above-described. X-ray diffraction intensity in Examples 1-1 to 1-4 was 0.4 to 2.3. Referring to FIG. 6, in the polycrystalline diamond of Example 1-2, the orientation of the (111) plane in the above-described evaluated surface was extremely low. It is noted that there was a difference found in orientation between the polycrystalline diamonds of Examples 1-1 and 1-2 produced under the same conditions. This is considered because the pressure applied to the carbon material or diamond with the ultra-high-pressure and high-temperature generator when directly converting the carbon material into diamond includes variances depending on the location.

On the other hand, in Comparative Examples 1-1 and 1-2, the ratio I₍₂₂₀₎/I₍₁₁₁₎ of the above-described X-ray diffraction intensity was 0.18 to 0.23. That is, the polycrystalline diamonds of Comparative Examples 1-1 and 1-2 were not oriented in any plane, but were isotropic.

In Comparative Examples 1-3 and 1-4, the ratio I₍₂₂₀₎/I₍₁₁₁₎ of the above-described X-ray diffraction intensity was 0.04 to 0.13, and the (111) plane was oriented in the above-described evaluated surface.

The wear resistance of each of the polycrystalline diamonds of Examples 1-1 to 1-4 and Comparative Examples 1-1 to 1-4 obtained as described above was measured by the following technique.

A wire drawing die having polycrystalline diamond was produced, and the wear resistance of the polycrystalline diamond was evaluated by the amount of wear of the wire drawing die (polycrystalline diamond) after a wire drawing test using the wire drawing die. Specifically, the wire drawing test was conducted at a drawing speed of 1000 m/min with a SUS wire used as a work piece, and the amount of wear of the wire drawing die after 5 hours was measured.

Referring to FIG. 3, wire drawing die 10 according to each of Examples 1-1 to 1-4 was produced by arranging, at drilled surface 13, the above-described evaluated surface ((111) low oriented surface) of polycrystalline diamond 11. Wire drawing die 10 according to each of Comparative Examples 1-1 and 1-2 was produced by arranging, at drilled surface 13, a surface obtained by cutting away polycrystalline diamond 11 in an arbitrary direction. Wire drawing die 10 according to each of Comparative Examples 1-3 and 1-4 was produced by arranging, at (killed surface 13, the above-described evaluated surface ((111) low oriented surface) of polycrystalline diamond 11. Table 1 shows the relative amount of wear when the amount of wear of Comparative Example 1-1 is assumed as 1.

Wire drawing die 10 according to each of Examples 1-1 to 1-4 had a small amount of wear and excellent wear resistance as compared with wire drawing die 10 according to each of Comparative Examples 1-1 and 1-4. That is, it is considered that wire drawing die 10 provided with the polycrystalline diamond of each of Examples 1-1 to 1-4 could have a large number of (111) planes of diamond oriented perpendicularly to wear direction f of the wire drawing die because the (111) low oriented surface of polycrystalline diamond 11 was arranged at drilled surface 13, so that excellent hardness characteristics and wear resistance of the (111) plane could be exhibited, it could also be confirmed that wire drawing die 10 provided with polycrystalline diamond 11 of Example 1-2 having a surface in which the (111) plane had lower orientation than in the other examples had a smaller amount of wear and more excellent wear resistance than the dies provided with the polycrystalline diamonds of the other examples.

On the other hand, it is considered that, in the wire drawing dies provided with the polycrystalline diamonds of Comparative Examples 1-1 and 1-2, the orientation of the (111) plane of diamond in the above-described wear direction is lower than in the wire drawing dies of Examples 1-1 to 1-4. It is considered that, in the wire drawing dies provided with the polycrystalline diamonds of Comparative Examples 1-3 and 1-4, the orientation of the (111) plane of diamond in the above-described wear direction is even lower than in the wire drawing dies of Comparative Examples 1-1 and 1-2 showing isotropy. Actually, the amount of wear of the dies of Comparative Examples 1-1 and 1-2 was larger than that of the dies of Examples 1-1 to 1-4. The amount of wear of the wire drawing dies of Comparative Examples 1-3 and 1-4 was larger than that of the dies of Examples 1-1 to 1-4, and was equivalent to or larger than that of the wire drawing dies of Comparative Examples 1-1 and 1-2.

### Example 2

Next, Example 2 of the present embodiment will be described.

Polycrystalline diamonds according to Examples 2-1 to 2-3 were manufactured by the following method. First, graphite having a degree of graphitization of more than or equal to 0.8 was prepared as a graphitic carbon material which is a non-diamond carbon material. Specifically, the degree of graphitization measured by X-ray diffractometry was 0.81 in the graphite of Example 2-1, 0.82 in the graphite of Example 2-2, and 0.85 in the graphite of Example 2-3.

Next, each of Examples 2-1 to 2-3 was subjected to a high-temperature high-pressure treatment with a high-pressure high-temperature generator under the conditions of a pressure of 15 GPa and a temperature of 2300° C. (at a pressure and a temperature at which diamond is thermodynamically stable) while applying moderate shearing stress without adding either a sintering aid or a binder. The graphite was directly converted into diamond and simultaneously sintered to obtain the polycrystalline diamond of each of Examples 2-1 to 2-3.

Polycrystalline diamonds according to Comparative Examples 2-1 and 2-2 were manufactured by the following method. First, graphite having a degree of graphitization of less than 0.8 was prepared as a graphitic carbon material which is a non-diamond carbon material. Specifically, the degree of graphitization measured by X-ray diffractometry was 0.32 in the graphite of Comparative Example 2-1 was, and 0.55 in the graphite of Comparative Example 2-2.

Next, each of Comparative Examples 2-1 and 2-2 was subjected to a high-temperature high-pressure treatment with a high-pressure high-temperature generator under the conditions similar to those in the examples. The polycrystalline diamonds of Comparative Examples 2-1 and 2-2 were thus obtained.

The X-ray diffractometer (X'Pert) provided by Koninklijke Philips N.V. was used for the X-ray diffraction conducted in this example for investigating the degree of graphitization of each graphite.

(Evaluation 2-1)

For the polycrystalline diamonds of Examples 2-1 to 2-3 and Comparative Examples 2-1 and 2-2 obtained as described above, the amount of impurities contained in each polycrystalline diamond was measured using SIMS. Specifically, the amount of each element of hydrogen (H), oxygen (O), boron (B), nitrogen (N), and silicon (Si) was measured. The measurement results are shown in Table 2

TABLE 2

| | | | | Polycrystalline Diamond | | | | | | | |
|---|---|---|---|---|---|---|---|---|---|---|---|
| | Material | | | Existence | | Crack length of | | | | | |
| | Degree of | Synthesis Conditions | | ratio of | Knoop | high-load Knoop | Amount of impurities (ppm) | | | | |
| | graphitization | Pressure | Temperature | layered part | hardness | indentation | H | O | B | N | Si |
| Example 2-1 | 0.81 | 15 GPa | 2300° C. | 98% | 130 GPa | 8 μm | <10 | <1 | <0.003 | <0.2 | <0.05 |
| Example 2-2 | 0.82 | 15 GPa | 2300° C. | 99% | 135 GPa | 6 μm | <10 | <1 | <0.003 | <0.2 | <0.05 |
| Example 2-3 | 0.85 | 15 GPa | 2300° C. | 99% | 130 GPa | 6 μm | <10 | <1 | <0.003 | <0.2 | <0.05 |
| Comparative | 0.32 | 15 GPa | 2300° C. | 35% | 130 GPa | 11 μm | 150 | 30 | 0.2 | 280 | 0.4 |
| Example 2-1 | | | | | | | | | | | |
| Comparative | 0.55 | 15 GPa | 2300° C. | 25% | 120 GPa | 12 μm | 130 | 40 | 0.2 | 300 | 0.4 |
| Example 2-2 | | | | | | | | | | | |

In the polycrystalline diamonds of Examples 2-1 to 2-3, the amount of impurities of all the elements was less than or equal the detection limit (less than or equal to 0.01 mass %). On the other hand, in the polycrystalline diamonds of Comparative Examples 2-1 and 2-2, all the elements of H, O, B, N, and Si were detected and measured. That is, it has been confirmed that the polycrystalline diamonds of Examples 2-1 to 2-3 have an impurity concentration lower than the polycrystalline diamonds of Comparative Examples 2-1 and 2-2 manufactured by the conventional direct conversion method.

(Evaluation 2-2)

Each of the polycrystalline diamonds of Examples 2-1 to 2-3 and Comparative Examples 2-1 and 2-2 was subjected to cross-section observation with a scanning electron microscope (SEM) to calculate the ratio (area ratio) occupied by the layered diamond in the observation visual field. Specifically, for each of the above-described polycrystalline diamonds, an arbitrary cross section was first formed. Next, the cross section was subjected to mirror polishing. Next, an arbitrary region of the cross section having been mirror finished was observed with the SEM in an observation visual field of 50 μm square to obtain an image of the observation visual field. Furthermore, in the image of the observation visual field, the ratio of the area occupied by the layered diamond to the total area of the polycrystalline diamond (the area occupied by the layered diamond in the image of the observation visual field/the total area of the polycrystalline diamond in the image of the observation visual field×100 (unit: %)) was calculated. Calculation results are shown in Table 2.

The above-described ratio in the polycrystalline diamond of each of Examples 2-1 to 2-3 was more than or equal to 90%. On the other hand, the above-described ratio in the polycrystalline diamond of each of Comparative Examples 2-1 and 2-2 was less than or equal to 35%. That is, it has been confirmed that the polycrystalline diamonds of Examples 2-1 to 2-3 have a larger amount of layered diamond than the polycrystalline diamonds of Comparative Examples 2-1 and 2-2 manufactured by the conventional direct conversion method.

(Evaluation 2-3)

Each of the polycrystalline diamonds of Examples 2-1 to 2-3 and Comparative Examples 2-1 and 2-2, the amount of impurities, the Knoop hardness, and the crack length of a high-load. Knoop indentation were measured.

The Knoop hardness was obtained by pressing a Knoop indenter against a polished surface of each polycrystalline diamond for 10 seconds at a load of 0.5 kgf under the temperature environment of 20° C. to 30° C., and then measuring the length of an indentation.

Measurement of the crack length of a high-load Knoop indentation was accomplished by pressing a Knoop indenter against the polished surface of each polycrystalline diamond for 10 seconds at a load of 2.0 kgf under the temperature environment of 20° C. to 30° C., and then measuring the length of a crack produced around the indentation. Test results are shown in Table 2.

The polycrystalline diamonds of Examples 2-1 to 2-3 had a Knoop hardness of more than or equal to 130 GPa, while the polycrystalline diamonds of Comparative Examples 2-1 and 2-2 had Knoop hardnesses of 120 GPa and 130 GPa, respectively. The polycrystalline diamonds of Examples 2-1 to 2-3 had a Knoop hardness equivalent to or more than that of the polycrystalline diamonds of Comparative Examples 2-1 and 2-2.

The polycrystalline diamonds of Examples 2-1 to 2-3 had a crack length of a high-load Knoop indentation of approximately 6 μm to 8 μm, while the polycrystalline diamonds of Comparative Examples 2-1 and 2-2 had a crack length of a high-load Knoop indentation of 11 μm and 12 μm, respectively. It has been confirmed that the polycrystalline diamonds of Examples 2-1 to 2-3 have resistance to crack propagation higher than that of the polycrystalline diamonds of Comparative Examples 2-1 and 2-2.

Although the embodiments and the examples of the present invention have been described above, the above-described embodiments and examples can be modified variously in addition, the scope of the present invention is not limited to the above-described embodiments and examples. The scope of the present invention is defined by the claims, and is intended to include any modification within the meaning and scope equivalent to the terms of the claims.

### REFERENCE SIGNS LIST

1, 11 polycrystalline diamond; 2 base metal; 3 brazing layer; 4 metallization layer; 5 cutting face; 7 flank; 10 wire drawing die; 12 through-hole; 13 drilled surface; 14 work surface.

1. Polycrystalline diamond comprising layered diamond and granular diamond,
said layered diamond being formed by laminating plate-like diamond layers,
when said polycrystalline diamond is observed in an arbitrary cross section, said layered diamond appearing at an observation visual field in said cross section occupying an area of more than or equal to 90% of the total area of said polycrystalline diamond in said observation visual field.

2. The polycrystalline diamond according to claim 1, comprising a surface in which a ratio I₍₂₂₀₎/I₍₁₁₁₎ of an X-ray diffraction intensity I₍₂₂₀₎ of a (220) plane of said diamond to an X-ray diffraction intensity I₍₁₁₁₎ of a (111) plane of said diamond is more than or equal to 0.35.

3. The polycrystalline diamond according to claim 1, further comprising a plurality of impurities other than said diamond, wherein
each of said plurality of impurities has a concentration of less than or equal to 0.01 mass %.

4. A tool comprising the polycrystalline diamond as defined in claim 1.

5. A method for manufacturing polycrystalline diamond, comprising the steps of:
preparing a carbon material made of graphitic carbon having a degree of graphitization in X-ray diffractometry of more than or equal to 0.8; and
directly converting said carbon material into diamond in a pressure and temperature range where diamond is thermodynamically stable.

6. The method for manufacturing polycrystalline diamond according to claim 5, wherein said step of preparing a carbon material includes the steps of
preparing an oriented carbon material having an orientation along a C-axis, and
subjecting said oriented carbon material to a heat treatment at more than or equal to 2000° C. to produce a carbon material in which a full width at half maximum of an X-ray diffraction peak of a (002) plane is more than or equal to 0° and less than or equal to 0.2°.

7. The method for manufacturing polycrystalline diamond according to claim 5, wherein
said carbon material prepared in said step of preparing a carbon material contains a plurality of impurities other than carbon, and
each of said plurality of impurities has a concentration of less than or equal to 0.01 mass %.
